(19) United States
(12) Patent Application Publication
(10) Pub. No.: US 2002/0156664 A1
(43) Pub. Date: Oct. 24, 2002

(54) Method and apparatus for service request handling

(76) Inventors: William J. Willcox, Maynard, MA (US); Timothy J. Martel, Lexington, MA (US); Wesley R. Porter, Medford, NJ (US); Ian S. Dembsky, Belmont, MA (US); Christopher L. Forbes, Groton, MA (US); Brian J. Harrigan, Maynard, MA (US); Aditya M. Raghavendra, Somerville, MA (US)

Correspondence Address: BROMBERG & SUNSTEIN LLP, 125 SUMMER STREET, BOSTON, MA, 02110-1618, US

(21) Appl. No.: 09/945,902

(22) Filed: Sep. 4, 2001

Related U.S. Application Data
(60) Provisional application No. 60/270,313, filed on Feb. 20, 2001.

(51) Int. Cl. G06F 17/60

(52) U.S. Cl. 705/7

(57) ABSTRACT

A method for processing a long running transaction for a service request includes receiving a service request at a workflow engine in communication with an original adapter and at least one receiving adapter wherein the original adapter generates the service request and the receiving adapter corresponds to a resource implementing a long running transaction in accordance with an instruction provided to the workflow engine by a business rule. The instruction is transmitted to the receiving adapter and an exception is received from receiving adapter. The exception is propagated to the business rule and to the original adapter. A notification indicating that the long running transaction is done is received from the receiving adapter, and the notification is propagated to the original adapter when all instructions provided by the business rule have been executed.

This application claims priority from provisional application No. 60/270,313, which was filed Feb. 20, 2001 and is hereby incorporated herein by reference.

### TECHNICAL FIELD

The present invention relates to service providers and, more particularly, to apparatuses and methods for handling service requests in a service provider environment.

### BACKGROUND ART

The communications marketplace is experiencing exponential growth in the number of services made available to subscribers. This rapid growth has resulted in increased demand on service providers to deliver these services quickly and accurately. Service providers are finding it difficult to scale up existing operational systems in order to handle this increased demand.

The Internet Protocol (IP) is responsible for the bulk of this growth. The ubiquity of IP dial tone, open nature of IP standards, and wide availability of development tools for IP networked applications has accelerated the need to integrate many disparate applications into cohesive end-to-end network solutions.

Services are implemented over a network on resources. Resources include e-mail servers, databases, routers, web self-registration systems, element management systems, billing systems, web servers, provisioning services and the like. Basically, a resource includes any system that must be updated in order for a customer or user to receive the service, be billed for the service, and for the service to be managed and monitored.

Most resources have at least some type of console or other GUI that is used to manage subscribers for that resource. This could take the form of a terminal, a Windows application, or a web based system. Additionally, many resources have Application Programming Interfaces (“API's”) that can be accessed with software that automatically establishes service for a new subscriber. For a single subscriber, there may be many resources that must be updated with new information. If the resources have consoles or web based management systems, somebody needs to walk from console to console, adding the customer information to each one.

Updates made to the resources as a result of a service request can either be ordered or unordered. For an unordered update, the updates on different resources can be initiated simultaneously. For an ordered update, resources are updated sequentially, one after the other. Depending on the nature of the service being provisioned, ordering of the resource updates may be important. For example, if there are two resources, such as a billing resource and a provisioning resource, the billing resource should be updated after the update to the provisioning resource is complete. In this manner, the customer is not charged for services he or she did not receive. Similarly, it is desirable to complete a credit card check before continuing with other resource updates such as provisioning or billing.

Data representation and the API exposed by a resource are referred to as the resource data model. One barrier to deployment of services to a large number of subscribers is caused by the fact that data models among resources vary widely in technology. Further, the data representation selected by a particular resource API also varies widely from system to system. For example, a command may be represented by numbers, and the “add subscriber” command could be represented by the value 1. Alternatively, the command field could be alphabetic, and the command could be represented by the value “add subscriber.”

There are few industry standards defining the operations needed to activate or update services on resources. Efforts have been made to allow resources running different data models to communicate with one another. For example, Extensible Markup Language (XML) has been used to implement a resource's API for exchange of commands and data between systems.

Another barrier to deployment of services to a large number of subscribers is the difficulty in determining where problems occur. Identifying the resource that generated an error can be difficult without proper diagnostic and audit information. Once the resource has been identified, determining detailed error information for that resource presents another challenge. Since there are no standard audit or error log capabilities for resources, each resource typically reports errors in a proprietary format. Some resources may provide scant and hard to decipher information buried in difficult to find locations, and documentation regarding error detection may be thin or non-existent. Such conditions require human experts well versed in the particulars of hard to use diagnostic information who are able to work with that information when it is presented in many different proprietary formats.

### SUMMARY OF THE INVENTION

In accordance with one embodiment of the invention, a method for processing a long running transaction for a service request includes receiving a service request at a workflow engine in communication with an original adapter and at least one receiving adapter. The original adapter generates the service request and the receiving adapter corresponds to a resource implementing a long running transaction in accordance with an instruction provided to the workflow engine by a business rule. The instruction is transmitted to the receiving adapter and an exception is received from the receiving adapter. The exception is propagated to the business rule and to the original adapter. A notification is received from the at least one receiving adapter indicating that the long running transaction is done when the long running transaction has completed. The notification is propagated to the original adapter when all instructions provided by the business rule have been executed.

In accordance with a further embodiment of the invention, a method for implementing a manual repair capacity for service requests includes configuring a workflow engine in communication with at least one adapter to allow for manual repair. An exception is received with regard to a pending service request at the workflow engine, and a message is transmitted to an operator interface to indicate to the operator that a repair is required. Information about a service request is also transmitted to the operator interface. In accordance with other embodiments of the invention, the exception may be re-thrown to the workflow engine by the operator and/or the instruction that resulted in the exceptions may be retried.

In accordance with another embodiment of the invention, a method for integrating multiple resources in a service provider environment includes transmitting a service request to a workflow engine, the service request including one or more components to be executed in accordance with instructions provided by a business rule in communication with the workflow engine, and receiving a notification that the one or more components of the service request have been executed. The method may further include receiving an exception from the workflow engine when one of the components of the service request has not been executed.

In accordance with a further embodiment of the invention, a method for processing in a workflow engine a service request that includes a long running transaction includes receiving a service request and entering an active state for processing the service request. Instructions are sent to receiving adapters in response to the service request and a long running transaction exception is received from one of the receiving adapters. A long running transaction state is entered, during which a long running transaction completion may be received, and a dormant state is entered until receipt of an indication of the long running transaction completion.

In accordance with yet another embodiment of the invention, an apparatus for processing a long running transaction includes an original adapter for generating a service request and a receiving adapter corresponding to a resource executing a long running transaction in accordance with an instruction corresponding to the service request. The receiving adapter transmits an exception when a long running transaction is executed. A workflow engine receives the service request from the original adapter and sends the instruction corresponding to the service request to the receiving adapter. The workflow engine include a state machine indicating the long running transaction is pending and propagates the exception to the original adapter.

In accordance with other embodiments of the invention, a computer program product for implementing an adapter includes program code for transmitting a service request in a system data model to a workflow engine and program code executable upon receiving a normal return from the workflow engine in response to the service request. The computer program product also includes program code executable upon receiving an exception from the workflow engine in response to the service request. The computer program product may also include program code for translating a service request in a resource data model into the service request in the system data model. The program code executable upon receiving a normal return may comprise code for indicating normal completion of the request to a resource that issued the service request. Additionally, the program code executable upon receiving an exception may include code for indicating failure of the request to a resource that issued the service request.

### BRIEF DESCRIPTION OF THE DRAWINGS

The foregoing features of the invention will be more readily understood by reference to the following detailed description, taken with reference to the accompanying drawings, in which:

FIG. 1 is a block diagram illustrating a system in accordance with one embodiment of the present invention;

FIG. 2 is a block diagram illustrating a logical view of a fault tolerance mechanism that may be used in connection with the system of FIG. 1 in accordance with a further embodiment of the invention;

FIG. 3 is a block diagram illustrating a physical view of the mechanism of FIG. 2;

FIG. 4 is a block diagram illustrating an audit solution that may be used in connection with the system of FIG. 1 in accordance with a further embodiment of the invention;

FIG. 5 is a flow chart illustrating a method for implementing a successful service request transaction in accordance with an embodiment of the invention;

FIG. 6 is a flow chart illustrating the method of FIG. 5 when an error occurs;

FIG. 7 is a flow chart illustrating a method for implementing a rollback using a two-phase commit protocol in accordance with another embodiment of the invention;

FIG. 8 is a flow chart illustrating a method for implementing a manual repair capability in accordance with another embodiment of the invention;

FIG. 9 is a flow chart illustrating a method for processing a long running transaction in accordance with further embodiment of the invention;

FIG. 10 is a block diagram illustrating a finite state machine implementing a basic transaction in accordance with an embodiment of the invention;

FIG. 11 is a block diagram illustrating a finite state machine implementing final transaction states in accordance with a further embodiment of the invention;

FIG. 12 is a block diagram illustrating a finite state machine implementing a long running transaction in accordance with another embodiment of the invention;

FIG. 13 is a flow chart illustrating a method for implementing a mechanism to recover from system failures in accordance with yet a further embodiment of the invention;

FIG. 14 is a block diagram illustrating a finite state machine implementing an orphan state in accordance with the embodiment of FIG. 13;

FIG. 15 is a block diagram illustrating an implementation of a business rule manager in accordance with an embodiment of the invention; and

FIG. 16 is a flow chart illustrating a method for updating a business rule in accordance with the embodiment of FIG. 15.

### DETAILED DESCRIPTION OF SPECIFIC EMBODIMENTS

The invention provides solutions to the problems encountered when attempting to service a large number of customers using a variety of different resources. The architecture of this invention unifies the functions of Operational Support System integration and workflow processing into a cohesive system that automates service activation and maintenance in a service provider environment and also provides effective and consistent handling of error conditions.

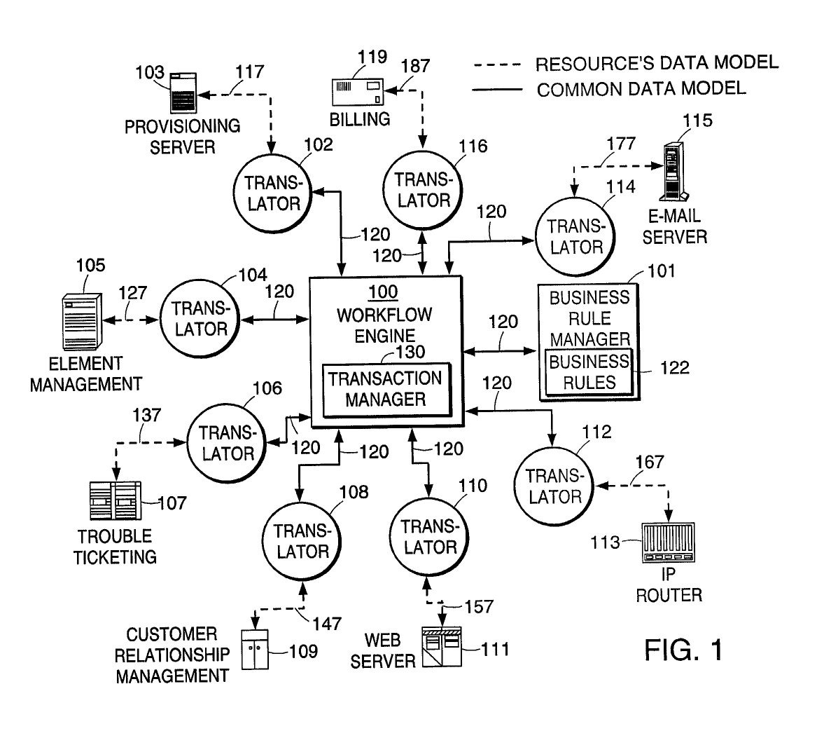

Referring to FIG. 1, the system includes one or more adapters in communication with a workflow engine 100. In the embodiment of FIG. 1, the adapters are translators 102, 104, 106, 108, 110, 112, 114 and 116. An adapter is an object that adapts the interface of one object to the interface expected by another object. It is an object that allows a requester to invoke a request on another object even though the requester does not know the other object's true interface. Translators are required where the data model of the requesting object differs from the data model of the receiving object. The workflow engine 100 handles infrastructure chores on behalf of the system components. It is responsible for managing an interface to one or more business rules 122, passing commands and data between the adapters and a plurality of business rules 122, managing the interactions with the adapters and managing transactions. All commands and requests pass through the workflow engine 100 before being delivered to the adapters. As will be discussed below, this allows the workflow engine 100 to maintain a record of a state of a service request at all times.

The workflow engine 100 is in communication with the business rule manager 101. The business rule manager 101 handles infrastructure chores for the business rules 122. Such chores include managing communications with the workflow engine 101, loading the business rules 122 to perform a service request, initializing structures required to process commands and data for the business rules, and passing commands and data between the business rules 122 and workflow engine 100. In accordance with a preferred embodiment, the business rule manager 101 runs on a separate virtual machine from that on which the workflow engine 100 runs. This separation permits the business rules to be changed dynamically, i.e., without shutting down the workflow engine.

The workflow engine 100 includes a transaction manager 130. The transaction manager 130 maintains a finite state machine for each transaction wherein the state of each transaction is stored. A service request typically initiates a transaction. A “transaction” is defined herein as a set of updates made to a resource, or a plurality of resources, as a result of a service request. In accordance with embodiments of the invention, a transaction follows a single distributed thread coordinated by the workflow engine 100 and the business rules 122.

It is desirable that transactions be atomic from the original adapter's point of view. Either all of the business rules' resource updates take place or none of them do. Atomicity ensures that a resource is not updated unless other resources necessary for service are also updated. For example, a billing system for a particular service will not be updated with a customer's billing information unless a provisioning resource has been updated to supply the customer with the service.

Transactions should be consistent from the customers' point of view. The resources are always in a consistent state. In other words, if the billing system has knowledge of a particular user, then certain characteristics of that user must be known, such as an IP address and an e-mail address. Transactions should also be durable in that a transaction's properties should be maintained across system failures.

Transactions should be isolated. That is, the resource updates are isolated from the outside world. Until a transaction is complete, outside users cannot see the partial updates made as part of the individual operations of the transaction. Policies need to be implemented in the resources to best maintain isolation of the transactions. A user should be precluded from making changes to his account if a transaction is pending for the account.

A thread is the name given to a path taken by a command as it traverses the system, and a distributed thread is formed when the command sender is on a different node in a network than a command receiver. A service request is a distributed thread that can spawn several threads and transaction legs. A “transaction leg” is a command issued from the business rules to an adapter via the workflow engine in order to execute a component of a service request. It is a component initiated by the workflow engine 100 in accordance with a business rule instruction. Identification of each transaction leg and its outcome are recorded by the workflow engine 100 via the transaction manager 130. The transaction leg identification may include the identity of the receiving adapter which may be by name or address. This record may be used by the workflow engine to send out commit calls upon successful completion of a transaction or to send out undo calls when performing a rollback after a failed transaction.

Each adapter is in communication with one resource. Resources may include, inter alia, provisioning server 103, element manager 105 (which assigns IP addresses for communication links), trouble ticketing resource 107 (whereby a customer may report problems for repair by a service representative or operator), customer relationship manager 109, web server 111, IP router 113, e-mail server 115, and billing manager 119.

In accordance with this embodiment, the adapters, workflow engine 100, business rule manager 101, and transaction manager 130 take advantage of middleware solutions provided by the Common Object Request Broker Architecture (CORBA), developed by the Object Management Group, and of industry standards such as JAVA, developed by Sun Microsystems.

Middleware is object-oriented software that connects two or more otherwise separate applications. Middleware solutions provide a robust messaging infrastructure that includes message management, naming services, transport protocols, and storage services. The CORBA and JAVA middleware enable synchronous distributed computing. Thus, when a component of the system issues a command or a function call, the middleware handles all aspects of the communication. The middleware constructs the message based on automatically generated code, delivers the message to the receiver, and causes the sender to wait until the receiver has processed the message. The middleware then returns control to the sender, reporting any exceptional conditions that may have occurred in the receiver. The middleware also manages all the information for a distributed thread including path control, messaging, data, and exceptions. In accordance with one embodiment, the middeware may be ORBACUS made and sold by Object Oriented Concepts of Billerica, Mass.

All system components connected to the workflow engine communicate with each other using a common system data model. The system data model (carried over lines 120) is established between the adapters and one or more business rules 122, via the workflow engine 100. The system data model incorporates those data elements and functions that are common to the resources and necessary for service interactions. The system data model also includes specialized APIs, as will be discussed further below, for handling a two phase commit procedure with functions such as commit, ignore, and undo and for handling long running transactions.

Typically, resource data models (carried over lines 117, 127, 137, 147, 157, 167, 177, and 187) of the various resources are different. If so, the adapters must be programmed to convert data from the system data model to the data model required by the resource in order to update the resource. The adapters accomplish this translation by encapsulating details of the resource's data model and API and using these encapsulated details to reformat the system command in a manner that will be understood by the resource. The adapters may also be programmed to reformat data transmitted by the resources to conform to the system data model.

Service requests originate from the resources and the resources may reside on different nodes in a network. A resource, for example customer relationship manager 109 passes a service request using its data model to its corresponding adapter 108. The adapter 108 creates a transaction identifier, converts the request to the system data model if necessary, and passes the request to the workflow engine 100. The adapter creating the transaction identifier and passing the request to the workflow engine 100, in this case adapter 108, is referred to herein as the original adapter.

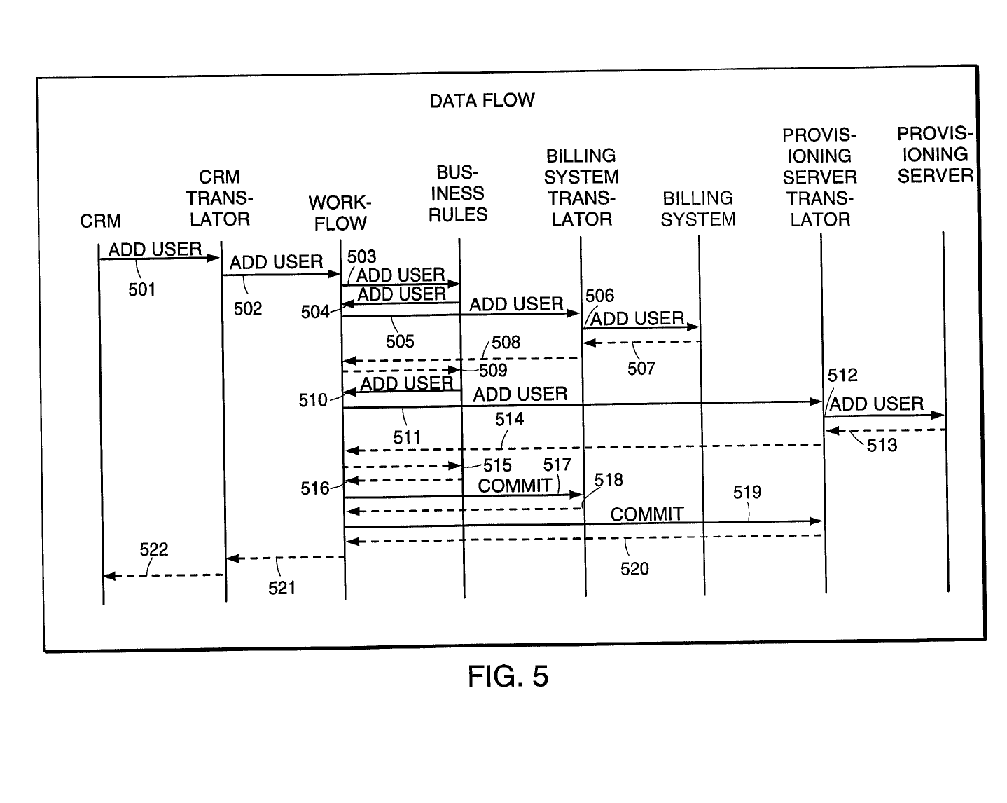

The workflow engine 100 passes the request to the business rules 122 via the business rule manager 101. The business rules provide the logic (or set of instructions) that determines the order in which the resources are updated as a result of the request. The business rule issues individual instructions to the adapters through the workflow engine 100 via business rule manager 101, and the workflow engine directs each instruction to the appropriate adapter. As each instruction is completed, the workflow engine seeks the next instruction from the business rule. Once the updates resulting from the service request are completed, the workflow engine returns the completed status of the request to the original adapter. The original adapter 108 returns the status to the resource 109. The process for implementing a basic service request transaction is described in detail below with respect to FIGS. 5-7.

A desirable characteristic of the workflow engine 100 is to support fault tolerant operations. In order for the system to be fault tolerant, single points of failure must be eliminated, and the system supports several techniques that ensure that elimination is accomplished.

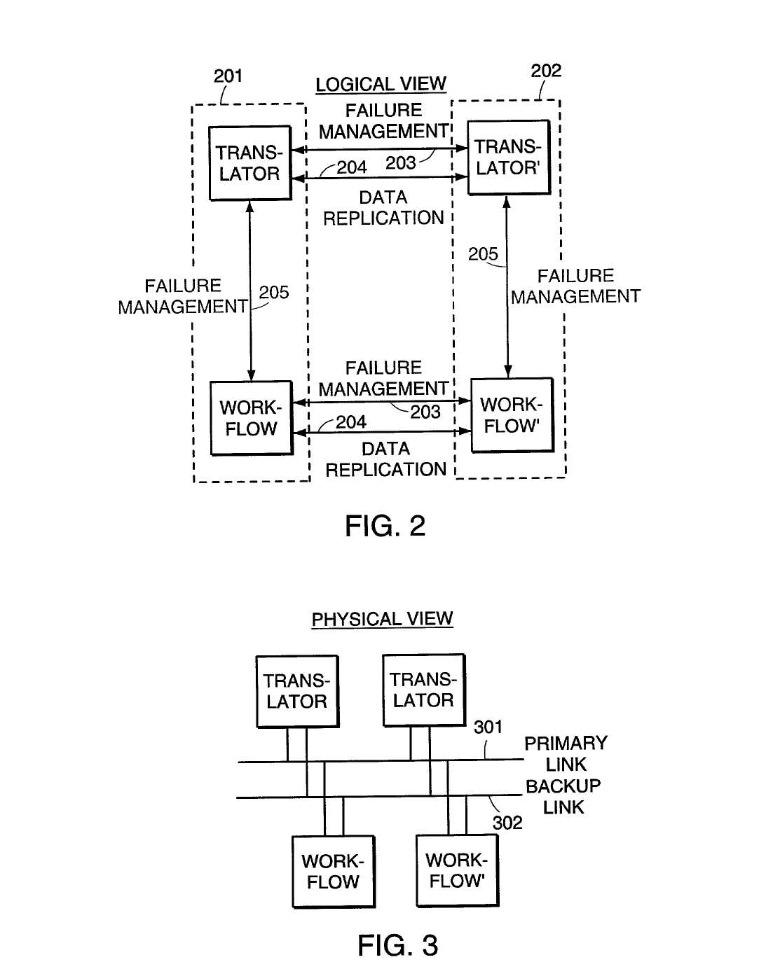

Redundancy is one of the primary techniques used to achieve fault tolerance. As shown in FIG. 2, the system architecture specifies primary and standby systems 201 and 202 respectively. Both of the systems 201 and 202 use identical hardware and software. Each system 201 and 202 is configured with redundant communication links 301 and 302 as shown in FIG. 3. Data critical to system operation is replicated from the primary system 201 to the standby system 202. The standby system 202 is therefore ready to continue operation in the event of a primary system 201 failure.

The system achieves fault tolerance between the primary and standby adapters and between the adapters and the workflow engine 100. Fault tolerance between the primary and standby systems includes failure management 203 and data replication 204. Since data and commands are passed between the workflow engine 100 and the adapters through the system, only failure management 205 is necessary between the workflow engine and the adapters. Failure management devices detect primary system failure and provide fail-over notifications to the system.

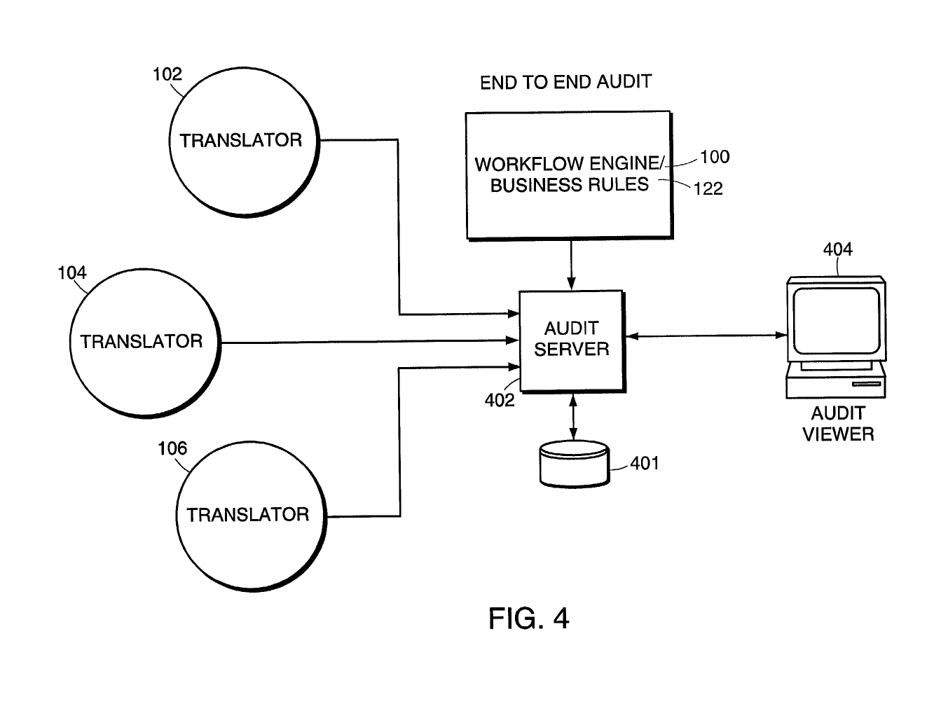

FIG. 4 is a block diagram illustrating an audit solution in accordance with another embodiment of the invention. The audit solution provides an improved diagnostic tool for error recovery. The audit solution specifies a central repository for audit data, such as a repository or database 401. Each adapter writes audit entries to this single audit repository 401 through audit server 402, as does the workflow engine 100 and business rules 122. A key corresponding to the transaction ID identifies the audit entries for a particular transaction. The keys allow audit entries to be correlated and presented in a serialized, end-to-end format for each transaction. This presentation enables an operator to view complete information about a particular transaction from a centralized location.

This end-to-end audit functionality may require a graphical display capability, such as audit viewer 404. The audit viewer 404 is a user interface. The display allows the operator to enter information identifying a particular service request. A search of the repository entries is performed based on the identifying key and the data is located and correlated. Correlated entries are displayed to the operator on the viewer 404.

The resources 103, 105, 107, 109, 111, 113, 115, and 119 employing the system, are either transactional resources or non-transactional resources. Transactional resources typically have only one interface at which updates are made. For example, in a transactional database system, all updates are made through database APIs such as Structured Query Language. The resource controls when updates are made visible to other database users and guarantees that users don't see partial updates for an in-progress transaction. Updates can only be seen when the transaction completes.

Transactional resources support a standard two-phase commit protocol. This is because transactional resources implement APIs that include “prepare,” “commit,” and “undo” calls. In accordance with a two-phase commit protocol, updates to the resources take place in two phases. During a first phase, called “prepare,” data corresponding to an update to a resource is saved to a temporary disk location and the resource returns a “vote” indicating whether the resource believes the transaction should continue. If the votes from all pertinent resources indicate that the transaction should continue, a “commit” is issued and the update is completed and made visible to other resource users. If one of the resources returns a negative vote, the transaction is aborted. Aborting a transaction involves sending an “undo” command to each resource that had returned a positive vote. As a result of the undo command, the data saved to the disk location will be deleted and the resource returns to the state it was in before the transaction began.

Resources such as e-mail servers and device provisioning systems are non-transactional. Non-transactional resources do not have a single point of update. Rather, non-transactional resources may have many interfaces by which they may be updated, including web based management interfaces, telnet interfaces, and SNMP interfaces. When the state of the resource is modified through one interface, it is impossible to keep other users from seeing the changed state via one of the other interfaces. When a non-transactional resource receives a command, it simply makes the update. There is no notion of a prepare phase in which the resource first writes to a storage location. The update is always made.

In accordance with an embodiment of the invention, a method is provided for implementing a two-phase commit protocol which works with non-transactional resources or transactional resources. In accordance with this method, the adapters implement “votes” in the form of normal returns or exceptions in a first phase, and commit and undo commands in a second phase. The commit and undo commands are provided by the system data model. Transactional resources are easily adapted as they issue and receive corresponding commands. The protocol of the adapters simulates transactional operation for non-transactional resources by implementing a two-phase commit protocol and managing resource updates, as shall now be described.

FIG. 5 is a flow chart illustrating the basic data flow for a successful service request transaction. In FIG. 5, solid lines represent function calls and non-solid lines represent returns from the function calls. A resource, for example customer service manager 109 transmits a request to original adapter 108 in process 501. The original adapter 108, in turn, transmits 502 the request and a transaction ID to the workflow engine 100. In issuing the request, the adapter 108 may convert the request from the resource's data model to the common system data model.

In accordance with an embodiment of the invention, the adapter 108 issues the request using a function call in a “try/catch” structure. The “try/catch” structure is implemented by all components of the system. When a function call is issued by a component, it is received in a “try” block. The component receiving the function call will attempt or try to execute the call. If there is an error (or other special circumstance, such as a long running transaction discussed below) associated with the attempt, an exception will be generated. An exception is a structure that communicates an abnormal processing condition. The exception is received or “caught” in a “catch” block. Logic contained in the catch block will dictate how the exception should be handled. Logic may be based on The particular error or circumstance or program flow may pass to logic serving as a catch all for non-enumerated errors.

Exceptions cause the normal flow of control to be aborted and special exception handling logic to be executed. The exception handling logic can dictate that actions are initiated to handle the error or circumstance and enable normal processing, or it can propagate the exception to the system middleware. The middleware may then propagate the exception to the sender, thus aborting its normal flow of control.

Exception handling is a powerful advance in workflow processing. It provides a highly structured approach to error processing in that new error conditions may be defined and new error handling logic may be added at will. Exception handling is supported by all state of the art middleware technologies. Thus, exceptions can be propagated across a distributed computing infrastructure.

The processing of a service request in an original adapter awaits a return indicating successful completion of the request. Middleware carries the request to the workflow engine 100 and then to and from a number of machines. The original adapter is oblivious to where the request is taken and its request thread awaits the return, just as if the request call were a simple subroutine call on its own machine. The alternative to a successful return from the request is the receipt of an exception. Thus, the service request acts as a single distributed thread which is treated synchronously by the adapter as it awaits a successful return or an exception.

The workflow engine 100 receives the service request from the adapter 108 and transmits 503 it to the business rule designated to perform the service request via the business rule manager 101. In the workflow engine, transaction manager 130 begins a record of the state of the service request, putting the request initially in an active state. The business rule provides 504 the workflow engine sequentially with a set of instructions for implementing the service request.

A transaction leg corresponding to a first instruction provided by the business rule is transmitted 505 from the workflow engine 100 to a receiving adapter, for example the billing system adapter 116, corresponding to a resource that will execute the instruction, such as the billing system resource 119. The transaction leg is then transmitted 506 to the resource 119. A normal return from the billing system is received 507 by the receiving adapter 116 and propagated 508 to the workflow engine 100. (The workflow engine 100 interprets normal return from an adapter as positive vote and exception from an adapter as negative vote.)

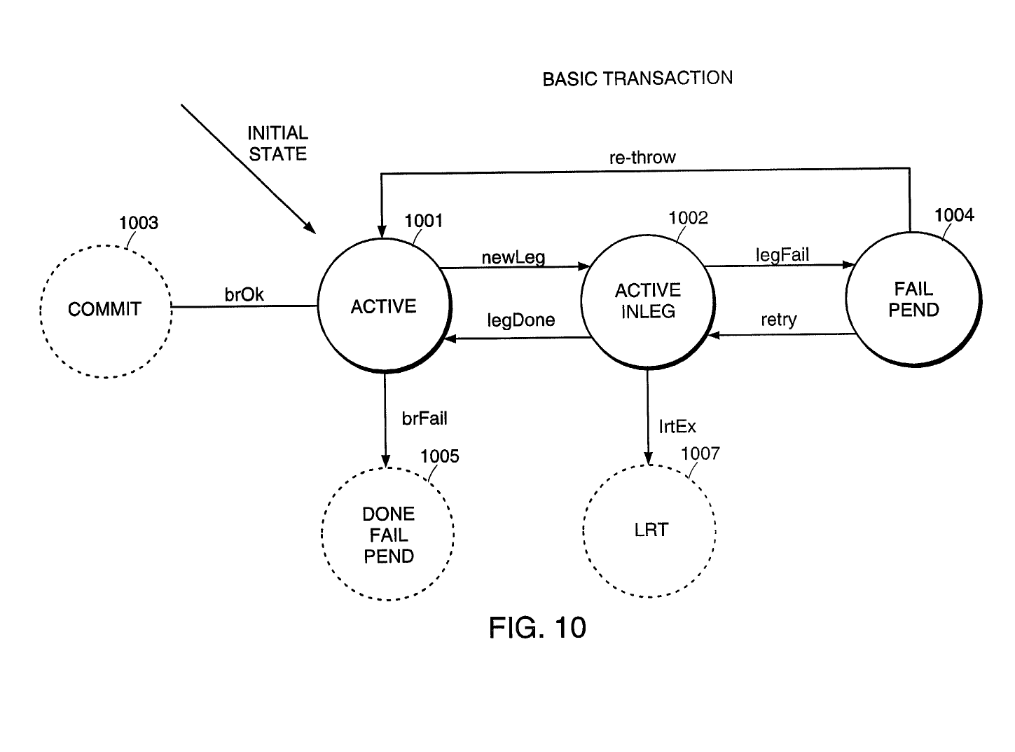

In the case of a non-transactional billing system, the update will be made. (In a transactional billing resource, the update will not be fully available until a commit call is received.) The receiving adapter 116 may save information corresponding to the updates made in the resources as a result of the service request in a persistent storage location. This will allow the receiving adapter 116 to recover after a system failure as discussed below in connection with FIG. 10. The workflow engine 100 makes a record of the transaction leg. The return is propagated 509 to the business rule 122 by the workflow engine 100.

The business rule 122 may provide the workflow engine 100 with another instruction, or call, 510 corresponding to the service request. If so, a second transaction leg will be transmitted 511 to a receiving adapter, perhaps provisioning service adapter 102, and the transaction leg will be propagated 512 to a second resource, such as provisioning server 103. When the provisioning server 103 has executed the transaction leg, the provisioning server adapter 102 will receive a normal return in process 513. As above, the receiving adapter 102 may save information corresponding to the updates made as a result of the service request in a storage location at the adapter. The vote (either normal return or exception) will be propagated 514 to the workflow engine 100. The workflow engine 100 propagates 515 the return or exception to the business rule 122.

Since, in this example, the business rule 122 has no further instructions, a return 516 from the initial service request will be propagated back to the workflow engine 100. Having received confirmation from the business rule 122 of successful action on the service request, the workflow engine 100 transmits commit calls 517 and 519 to each of the receiving adapters identified in the transaction record maintained by the workflow engine 100. The transaction manager of the workflow engine puts this service request in the commit state. Here a commit call is transmitted 517 to the billing system adapter 116, which generates 518 a normal return, and transmitted 519 to the provisioning server adapter 102 which also returns 520 normally. For the non-transactional resources, the updates have already been made to the resources 103 and 119, so the commit calls simply prompt the receiving adapters 102 and 116 to delete the data that was previously saved in persistent storage. For transactional resources, the commit is forwarded to the resource.

When all of receiving adapters (here 102 and 116) have returned normally from the commit call, the workflow engine will propagate the return 521 to the original adapter 108 and the original adapter will propagate the return 522 to the requesting resource 109. In this embodiment, a subscriber was added to the billing system and the new subscriber was provided with service via the provisioning server. The request was only completed when both systems had indicated that they did fulfill their instruction for the add subscriber service request.

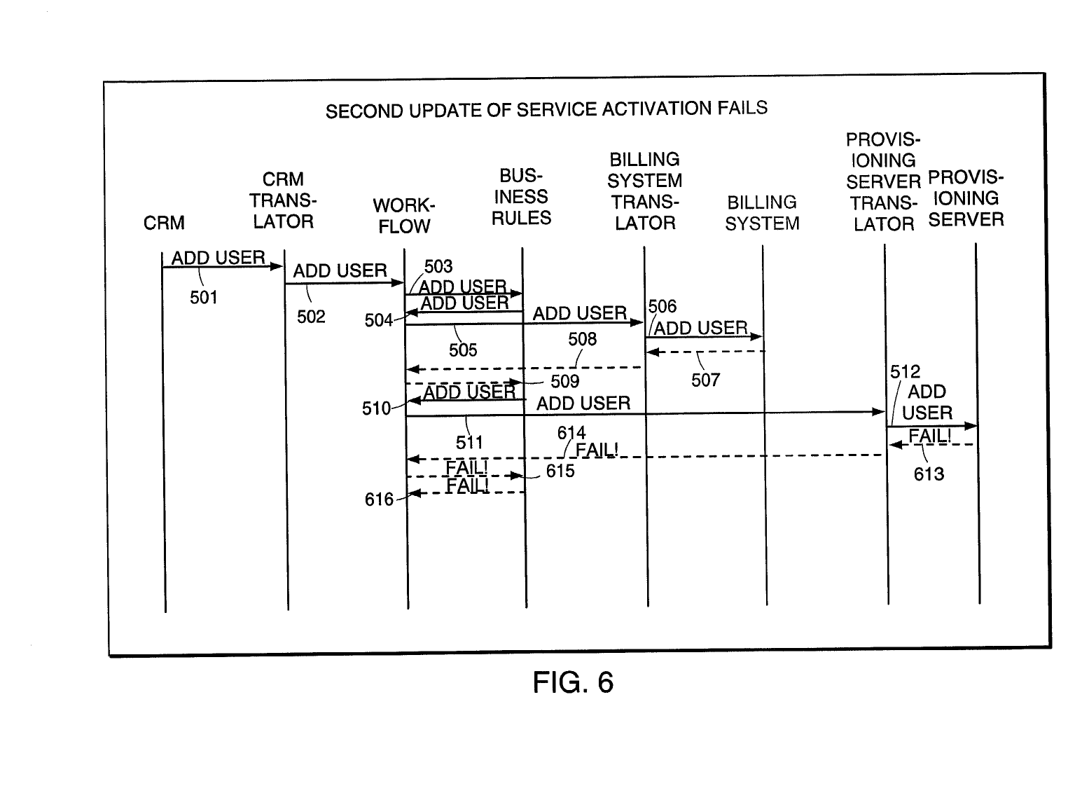

FIG. 6 is a flow chart illustrating the method of FIG. 5 when an error occurs. Here, the data flow proceeds in accordance with the method of FIG. 5 until the call is transmitted 512 to the provisioning server 103. The provisioning server 103 cannot execute the call, and a negative vote (or abnormal return) is returned 613 to the provisioning server adapter 102. The adapter 102 generates 614 an error exception to the workflow engine 100 and the state of the service request is updated via the transaction manager 130. The workflow engine 100 propagates 615 the exception to the business rule 122 via the business rule manager 101 and receives an exception 616 from the business rule 122. A system can be programmed to handle errors in any of a number of ways. Some errors may be ignored. Others may be treated by allowing a system operator to correct the error or decide upon how to proceed. An error may also be fatal to the service request, requiring a rollback of all the transaction legs that were completed up until the error. The response to an error can be a general response applicable to any exception or there may be specific responses in a catch phrase directed to the particular type of error indicated by the exception.

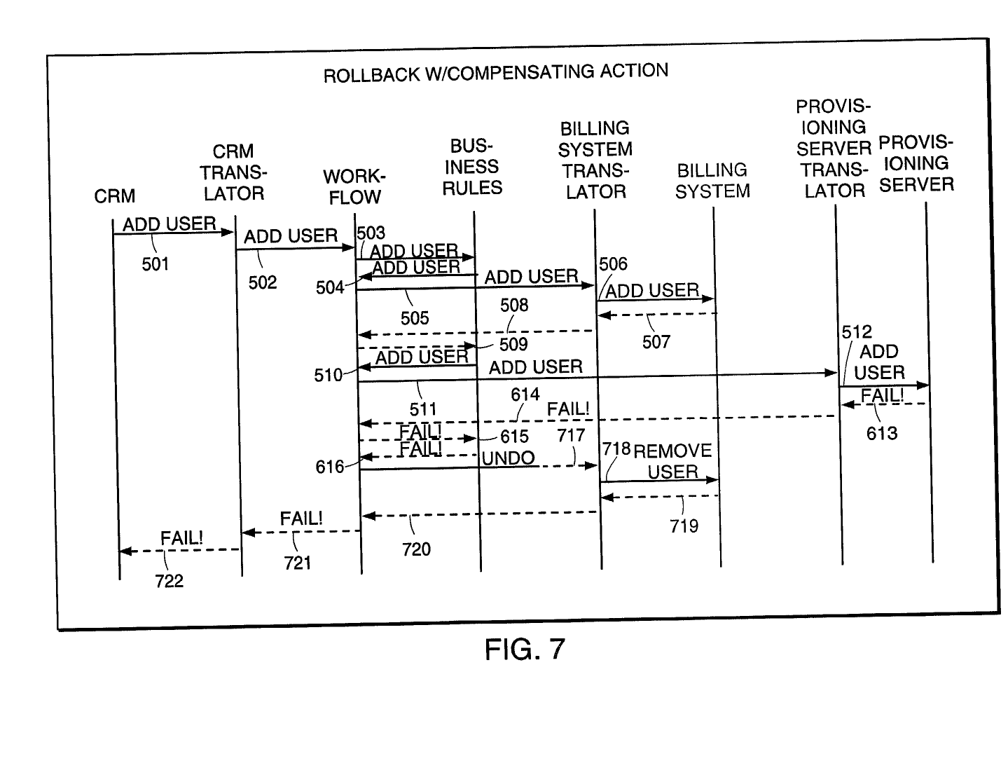

Referring now to FIG. 7, an example is shown for responding to an error with a rollback. A rollback aborts a transaction and undoes the changes made as a result of the transaction. When the workflow engine receives the exception 616 from the business rule 122, it may transmit 717 an “undo” call to every receiving adapter that has updated a resource as part of the transaction, here it is just the billing system adapter 116. The undo call prompts the adapter 116 to issue 718 a compensating action. A compensating action is a command that reverses any updates made to the billing system 119 (or other resource) as a result of the service request. For example, if the transaction leg sent to the billing system 119 comprised an “add user” command, a compensating action would be a “remove user” command. The adapters contain the logic for implementing compensating actions for a non-transactional resource. For transactional resources on the other hand, the undo can be simply forwarded to the resource.

The billing system 119 either returns 719 normally to the adapter 116 in response to the compensating action or an exception may be generated (not shown). If the billing system 119 returns normally, the adapter 116 propagates 720 the return to the workflow engine 100, thus acknowledging the undo command. If the billing system 119 cannot accomplish the undo, the adapter 116 will try again. A predetermined number of such tries may be established in the adapter. If the undo still cannot be completed, an exception sets off an alarm action as the system has experienced an uncorrected error. Upon successful completion of the undo by all the adapters involved in the service request, the workflow engine 100 will propagate 721 the failure exception to the original adapter, here, customer relationship management adapter 108. The exception is picked up by the catch block for the service request and the appropriate failure handling instruction is followed. For example, the adapter may notify 722 the customer relationship manager resource of the failure.

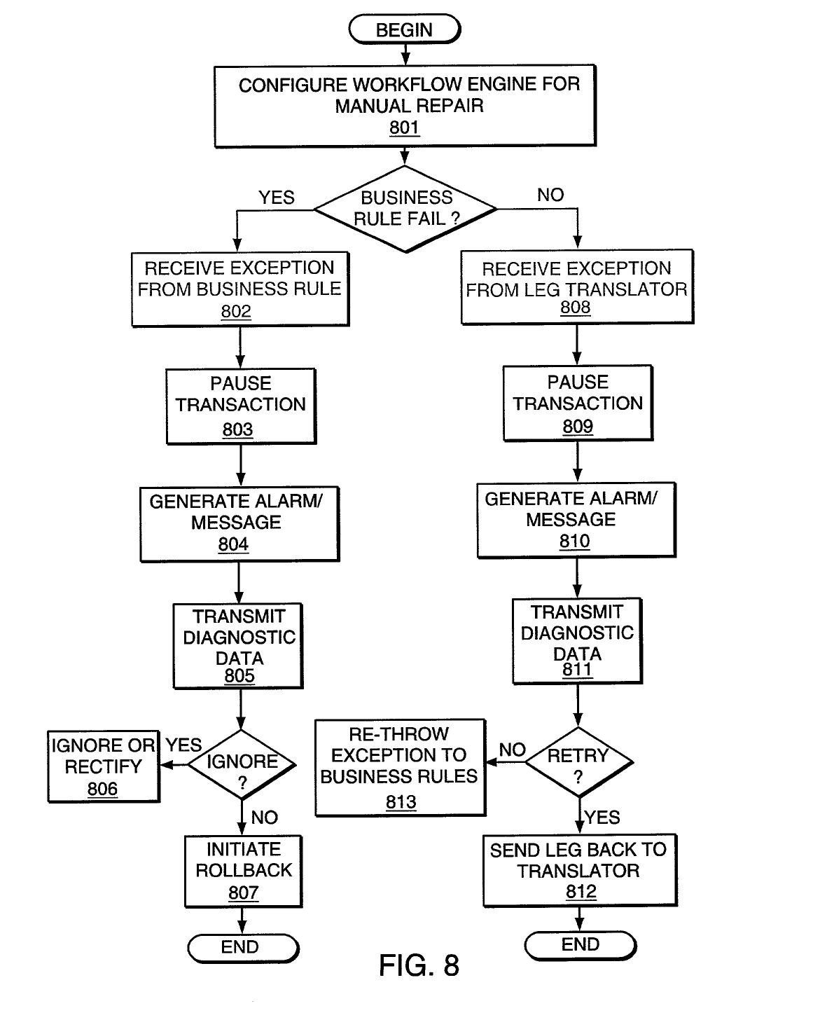

FIG. 8 illustrates a method for preventing automatic undoing of transactions that have encountered an error. In the service provider environment, there are cases when automatic undo commands issued due to error conditions are undesirable. Perhaps service for an important customer is being activated, the customer service representative has gone home, and many resource updates are required to complete a transaction. If one of the resource updates fails and the transaction is undone automatically, each successfully completed step will be undone. If this happens, the entire order will have to be re-entered. This may be undesirable.

First, the workflow engine 100 is configured 801 for manual repair. This could be indicated by an “on” or “off” status. When in the on state, the manual repair capability is executed. There are two primary stages of transaction processing during which the manual repair capability can take place, transaction leg failures and business rule failures. If a business rule 122 fails, an exception from the business rule is received 802 by the workflow engine via the business rule manager 101. Because the workflow engine is configured for manual repair, the transaction will be paused 803. An alarm or message will be generated 804 to a system administrator notifying an administrator or operator of the failure. The workflow engine also transmits 805 sufficient diagnostic information from the transaction thread to allow the operator to locate the offending component. The system administrator or operator may choose to ignore the message, either because the problem is trivial or because the system administrator is sure the problem can be rectified 806, or the system administrator may initiate a rollback 807.

If the workflow engine is configured for manual repair and a transaction leg fails, the workflow engine will receive 808 an exception from the adapter implementing the transaction leg. Again, the transaction is paused 809 by the workflow engine and the workflow engine generates an alarm or message in process 810 to notify operational staff. The workflow engine also transmits 811 sufficient diagnostic information from the transaction thread to allow an operator to locate the offending component. If the operator is able to make the repair, a transaction disposition can be set to “retry” whereby the transaction leg is again sent 812 to the receiving adapter. If the operator has not attempted to make the repair or cannot make the repair, the transaction disposition is set to “re-throw” and the exception is re-thrown 815 to the business rules via the workflow engine 100 and the business rule manager 101.

Many of the resources in the service provider environment deal with external events that take a long time to complete relative to other operations. A “truck roll” is a good example. A truck roll implies scheduling a service representative to drive to the subscriber location to perform some installation activity. There are two assumptions made about the truck roll event. First, the truck roll must be completed in order to complete the overall service request. Second, the truck roll may need to complete before other parts of the transaction can continue.

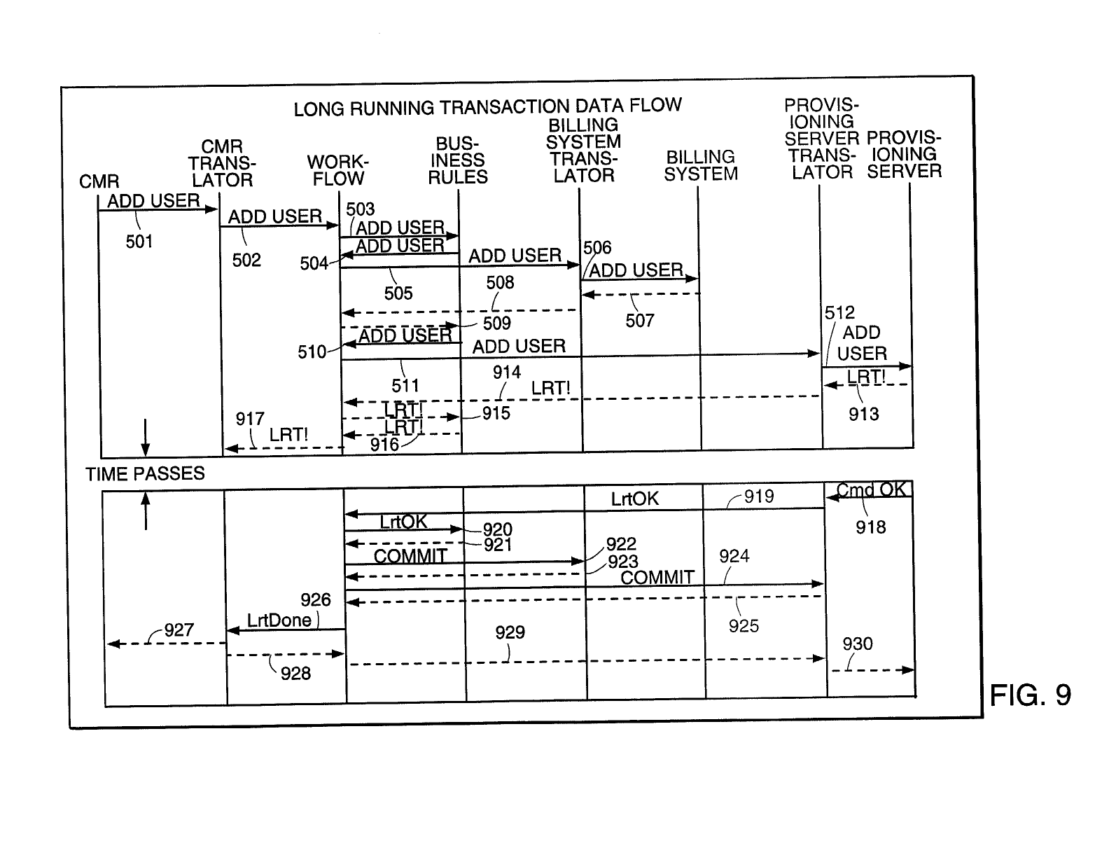

FIG. 9 is a flow chart illustrating a method for processing long running transactions in accordance with a further embodiment of the invention. The data flow proceeds in accordance with the method of FIG. 5 until the call is transmitted 512 to a resource that initiates a long running transaction (“LRT”). In the example of FIG. 9, the provisioning server 103 initializes an LRT and transmits 913 an indication (through an LRT exception according to one embodiment) that the transaction is long running to the provisioning server adapter 102. The adapter 102 may save information about any updates made to the provisioning server 103 in accordance with the LRT in a storage location. Such information may include an identification of the business rule that generated the instruction such that the business rule will be notified when the long running transaction is complete. The adapter 102 also propagates 914 the LRT exception to the workflow engine 100. The workflow engine 100 propagates 915 the LRT exception to the business rule 122, which transmits 916 a return to the workflow engine. The workflow engine 100 also propagates 917 the LRT exception to the original adapter 108 to inform the adapter 108 that the transaction is long running. The thread in the original adapter 108 that initiated the service request blocks in response to the LRT exception and awaits successful completion of the long running transaction or an exception indicating failure.

When the LRT is completed, the provisioning server 103 will transmit 918 an indication that the LRT is done to the provisioning server adapter 102. (This may involve the creation of a new thread at the provisioning server adapter.) The adapter 102 will transmit a completion notification 919 to the workflow engine 100 indicating that the LRT has completed. In turn, the workflow engine 100 will propagate 920 the notification to the business rule 122. When the business rule returns normally 921, workflow engine 100 will transmit a commit call 922 to the billing system adapter. When the billing system adapter returns 923, the workflow engine will transmit 924 a commit call to the provisioning server adapter. When the provisioning server adapter returns 925 normally, the workflow engine will propagate 926 the completion notification to the original adapter 108. The original adapter 108, notifies 927 the originating resource 109 and returns 928 to the workflow engine 100. The workflow engine 100 propagates 929 the return to the adapter implementing the LRT, here adapter 102, which propagates 930 the return back to the resource executing the LRT, provisioning server 103.

The business rules receive long running transaction exceptions when performing resource updates from adapters managing long duration resources. The business rules may also receive such an LRT exception as part of the command issued from the originating adapter, or in response to additional updates made in response to the completion notification of a long running transaction. When the business rule 122 receives a LRT exception from the workflow engine 100 it may instruct the workflow engine 100 to implement another transaction leg in accordance with the service request and/or it may save state information about the LRT which may be used during notifications. Similarly, the business rule 122 may respond to a LRT completion notification by instructing the workflow engine 100 to perform updates on other resources, make local data updates based on the result of the LRT, or delete state information that was previously stored. The business rule 122 must be aware that completion notifications originate from the receiving adapters corresponding to the resource implementing the long running transaction updates, not from the originating adapter.

Resource updates made in response to an LRT exception may return additional LRT exceptions. Thus, the workflow engine 100 must keep track of LRT completion notifications associated with a transaction, and the transaction state must be updated to reflect that an LRT leg is complete. If the LRT completes before the workflow engine receives a normal return from the business rule, the workflow engine will wait for the business rule to return before sending a LRT completion notification to the original adapter. If the business rule returns before all LRT completion notifications associated with a particular transaction have reached the workflow engine, the workflow engine will enter a dormant state for the transaction until all LRT completion notifications are returned.

When all the LRTs are completed, and the business rule has returned normally, then the workflow engine will transmit a commit call to all the adapters involved in the transaction and transmit a LRT completion notification to the original adapter. If all the LRTs are completed and the business rule has not returned normally, the workflow engine will initiate a rollback if necessary. In other words, all transaction legs and LRTs associated with a service request must be completed successfully before the workflow engine transmits a completion notification to the original adapter.

It may be that multiple resources have long running semantics. In this scenario, the business logic might require that updates to more than one resource be ‘kicked off’ in parallel. The business logic simply continues making updates in response to long running transaction exceptions returned by the adapters.

Referring now to FIGS. 10-12, the flow in state machines implemented by the transaction manager 130 in the workflow engine 100 in connection with a transaction is shown. When a service request and transaction ID are transmitted to the workflow engine from an original adapter, the transaction enters a transaction active state 1001. In accordance with instructions from the business rule 122, the workflow engine 100 will generate one or more transaction legs as was noted above. The transaction will enter a leg active state 1002 with each transaction leg generated by the workflow engine.

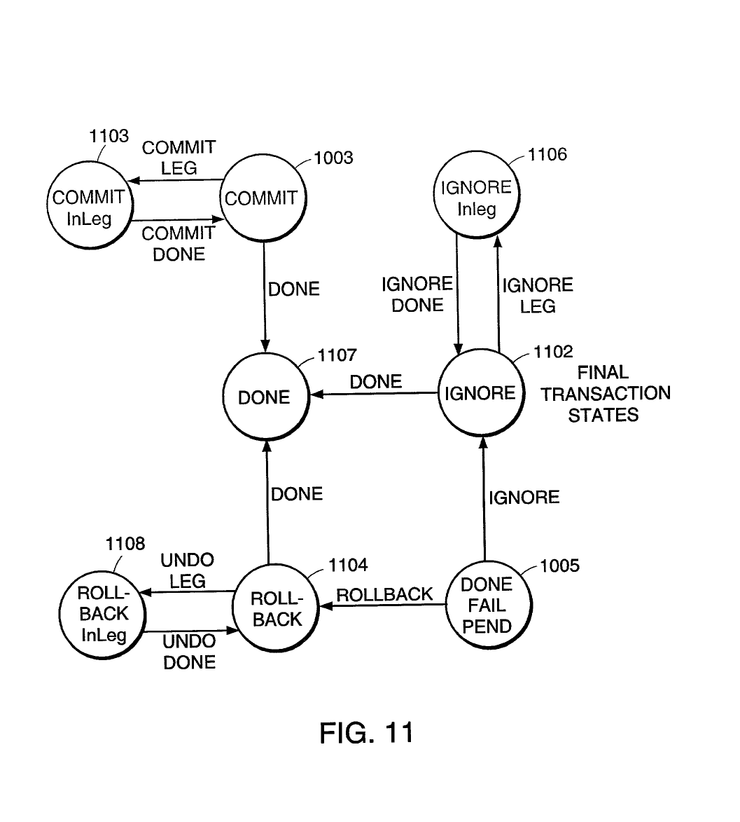

In a first scenario, an update is made to a resource as a result of a transaction leg, and the transaction leg returns normally to the workflow engine 100. Again, other transaction legs may be generated to comply with the business rule 122, thus the transaction alternates between the transaction active state 1001 and the leg active state 1002 until all the transaction legs return normally. When all of the transaction legs have returned normally and the business rule has returned normally, the transaction will enter a commit state 1003 (also see FIG. 11.) In the commit state 1003, the workflow engine will generate a commit call to each adapter so that the adapter may delete updates it has saved. With each commit call generated, the transaction enters a commit leg state 1103.

In another scenario, a transaction leg generated by the workflow engine 100 may fail and the transaction will enter a fail/pend state 1004. If the workflow engine has been configured for manual repair, an operator will be given a chance to intervene. If the operator chooses to re-try the transaction leg the transaction will again enter the active leg state 1002. If the operator decides to re-throw an exception to the business rule or if the workflow engine has not been configured for manual repair, the business rule will respond to the exception by ignoring it or propagating it. The exception may be ignored when the business rule has been programmed to recognize it as a nonfatal or insignificant error. The business rule then proceeds as if the leg was completed successfully. If the exception cannot be ignored by the business rule, the exception will be propagated through the workflow engine to indicate a business rule fail. In the workflow engine, the transaction will enter the done/fail/pend state 1005.

In response to the business rule fail, the workflow engine may try manual repair if so configured. If, nevertheless, the business rule remains failed, the transaction will change from the done/fail/pend state to either an ignore state 1102 or a rollback state 1104. The rollback state 1104 is the default, but through the manual repair process an operator may choose to enter the ignore state 1102 and have the transaction completed in spite of the error. While in the ignore state 1102, the workflow engine will generate an ignore call to each adapter so that the adapter may delete updates it has saved. Ignore calls are handled essentially the same way as commit calls. With each ignore call generated, the transaction enters an ignore leg state 1106 until the transaction has completed and enters a done state 1107. A normal return is sent to the original adapter. From the rollback state 1103, the transaction will enter a rollback leg state 1108 with each undo call the workflow engine generates until all updates have been reversed and the transaction enters the done state 1107. An exception is propagated to the original adapter indicating that the service request failed.

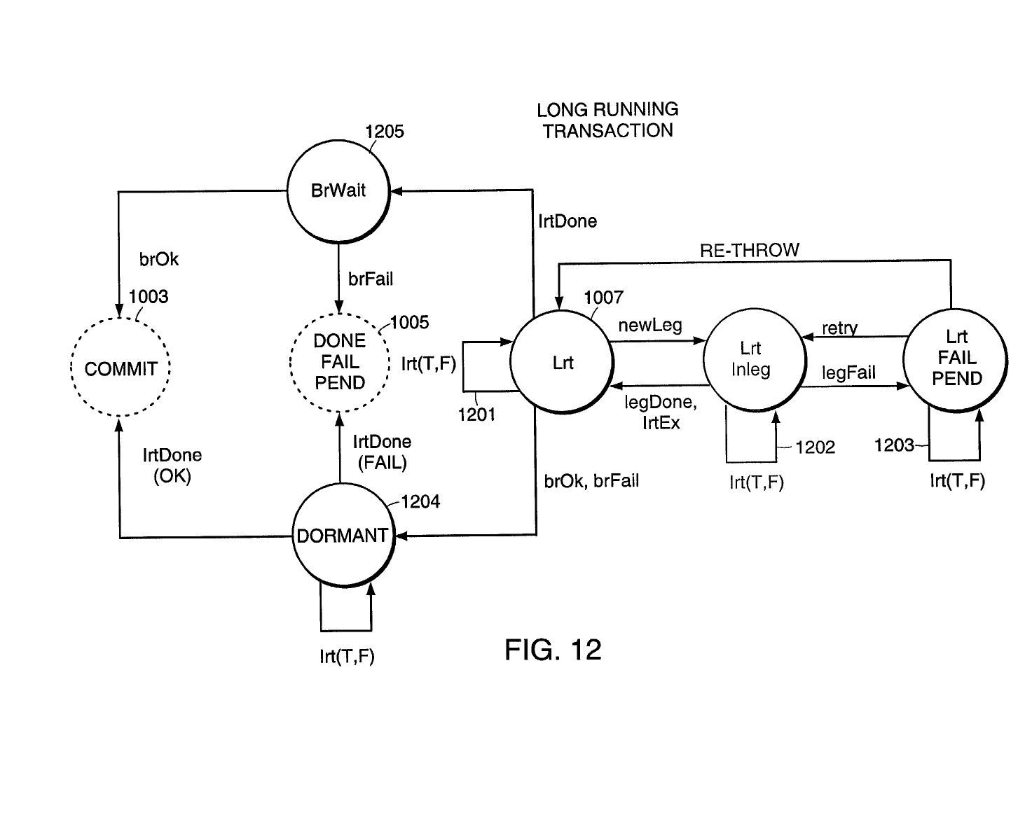

In yet another scenario, a transaction leg generated by the workflow engine may be a LRT, at which point the transaction will enter an LRT state 1007 in FIG. 10. The transaction is no longer a basic transaction, but is handled by the LRT states of FIG. 12. In the LRT state 1007, the workflow engine 100 maintains a count of all LRT completion notifications it receives, as was noted above in connection with FIG. 9. Arrows 1201, 1202, and 1203 indicated the receipt of a completion notification. The business rule 122, having received a LRT exception, may choose to continue the transaction without receiving a completion notification, and subsequent transaction legs may be generated by the workflow engine in accordance with business rule instructions. These subsequent transaction legs are handled in the same manner as the legs of a basic transaction, described with respect to FIG. 10, except that an LRT completion notification may be received at any time during the execution of these legs, as indicated by arrows 1202 and 1203. Note, that as was the case in the basic transaction, the subsequent transaction legs may themselves be LRTs.

While in the LRT state 1007, one of two scenarios may arise. The workflow engine 100 may receive an LRT completion notification or the workflow engine may receive a return from the business rule 122. If the workflow engine receives a return from the business rule 122, it will check to see if all the LRT completion notifications associated with the transaction have returned. If not, the transaction will enter a dormant state 1204. If all LRTs are eventually completed successfully and the business rule has returned successfully, the transaction will enter a commit state 1003 and proceed as described above in connection with FIG. 11. If one of the LRTs fails or the business rule fails, then the transaction will enter the done/fail/pend state 1005.

If the workflow engine 100 receives all completion notifications before it receives a return from the business rule 122, the transaction will enter a wait state 1205. If the business rule 122 eventually returns normally, the transaction will enter the commit state 1003. If the business rule returns an exception, the transaction will enter the done/fail/pend state described with respect to FIG. 11.

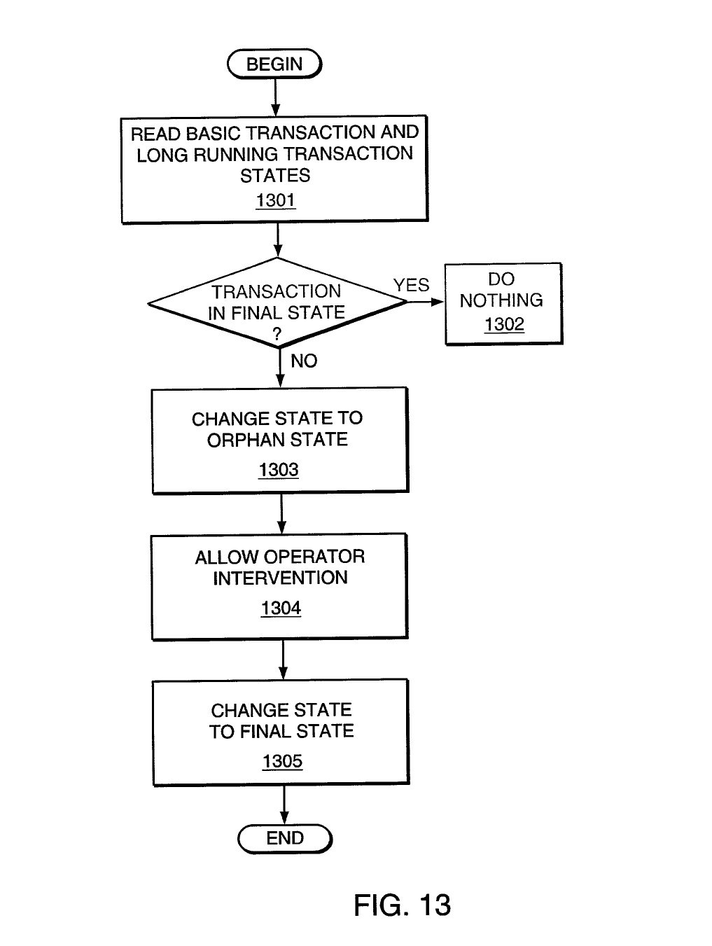

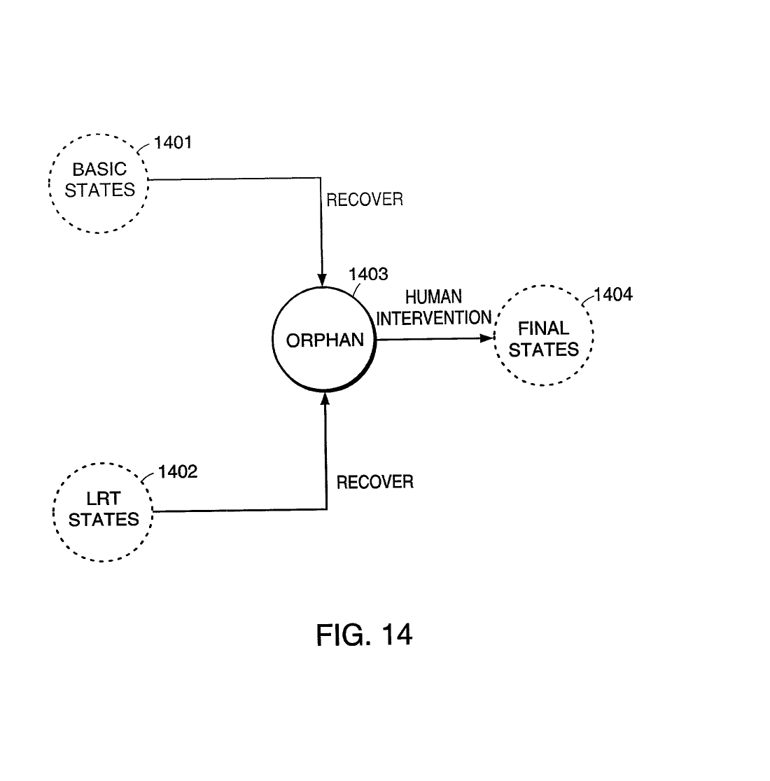

FIG. 13 is a flow chart illustrating a method for implementing a mechanism to recover from system failures in accordance with yet a further embodiment of the invention, and FIG. 14 is a block diagram illustrating a finite state machine for implementing an orphan state in accordance with the embodiment of FIG. 13. When the system is restarted after a system failure, the workflow engine 100 reads 1301 the basic transaction states 1401 of FIG. 14 and the long running transaction states 1402 from the transaction manager 130. If the transaction is in a final state, the workflow engine does nothing 1302 to the state and simply resumes performing service requests as above. If the transaction is not in a final state, the workflow engine will change 1303 the transaction state to an orphan state 1403. The orphan state 1403 allows for human intervention, in process 1304, at which point the final disposition of the transaction is determined by an operator or customer service representative. The transactions in the orphan state may then be put 1305 into a final state 1404 when their disposition has been determined.

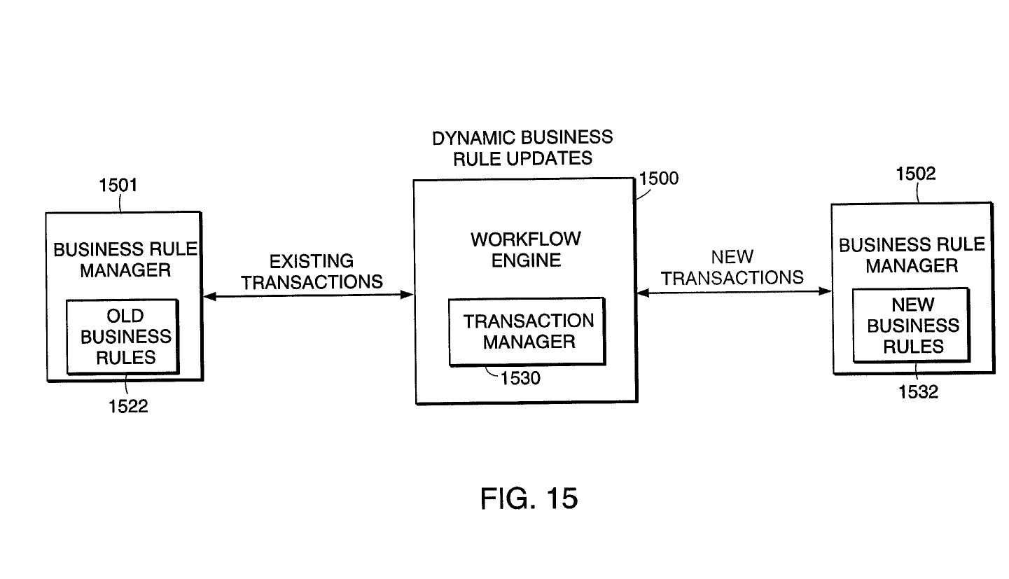

Finally, there are many situations when the business logic must be updated. The business rules may have to be updated to install bug fixes in the business logic, to add new functionality to the rules, or to incorporate new resources into the service activation process. A new business rule can provide a new set of instructions for a known service request. A new business rule may be required to interpret a new service request. With most existing systems, business logic updates require the system to be shut down while the update takes place. FIG. 15 is a block diagram illustrating implementation of a business rule manager that facilitates dynamic business rule updates in accordance with an embodiment of the invention. The workflow engine 1500 and its corresponding transaction manager 1530 reside on a different virtual machine than business rule manager 1501 or business rule manager 1502. Business rule manager 1501 corresponds to at least one old business rule 1522 and business rule manager 1502 corresponds to at least one new business rule 1532.

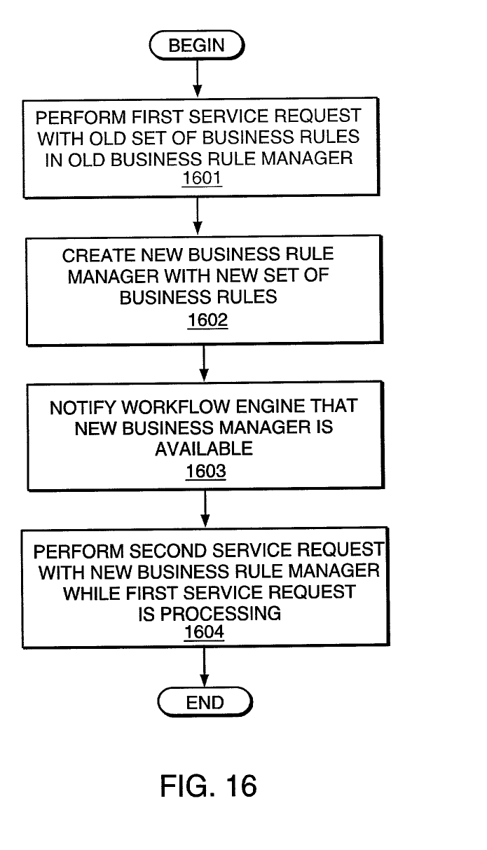

Referring now to FIG. 16, a first service request is performed 1601 with the one or more old business rules of business rule manager 1501. New business rule manager 1502 is then created 1602 to include one or more new business rule 1532. The new business rule manager 1502 notifies 1603 the workflow engine 1500 to announce the availability of the new rule business rule 1532. This notification occurs while the workflow engine 1500 is executing the old business rule 1522 for the first request. Transactions already executing while this process takes place are completed using the rule set in use when the transaction was started, here business rule 1522. The workflow engine 1500 executes subsequent service requests using the business rule 1532 associated with the new business rule manager 1502 in process 1604. These mechanisms provide a seamless way of introducing new business logic into the system while completing existing transactions on existing rules.

Some embodiments of the invention may be implemented at least in part in any conventional computer programming language comprising computer program code. For example, preferred embodiments may be implemented in a procedural programming language (e.g., “C”) or an object oriented programming language (e.g., “Java,” “C++”). The following and the attached Appendices A-C illustrate aspects of the invention implemented in JAVA code:

public ReturnStatus add_customer(char[] customerName) {

TID tid = new TID(); / /allocate transaction ID/ /
ReturnStatus s = new ReturnStatus(ReturnStatus.SUCCESS);
try {
/ /translate command/ /

String customerNameString =newString(customerName);

/ /call add command in workflow engine/ /
wf.add (tid, customerNameString);
} catch (LRTException e) {

Systme.out.println(“Caught LRT Exception”);
/ /block thread/ /
s = LrtHelper.waitForLrtDone(tid);

} catch (Exception e) {

s = new ReturnStatus(ReturnStatus.FAILURE);

}
return s;
}

Above, an “add customer” command is initiated in an original adapter and a transaction ID is created. The command is translated from the data model of the resource (here, a character array) to the data model of the system (a string). The command and the transaction ID is passed to the workflow engine via the wf.add() call. In this example, there are two catch clauses, one for an LRT exception, and one for errors. If an error exception is caught, the function will return a status of failure. If an LRT exception is caught, the system will wait for the final completion notification using the LrtHelper class below, and the thread will block while waiting for the completion notification. Otherwise, the call will return successfully.

The LrtHelper class provides synchronization help for long running transactions:

public class LrtHelper {

public static ReturnStatus waitEorLrtDone(TID t) {
try {

synchronized (t) {
t.wait();
}

} catch (Exception e) {

return new ReturnStatus(ReturnStatus.FAILURE);
}

return t.s;

}
public static void signalLrtDone(TID t, ReturnStatus s) {

t.s =s;
synchronized (t) {
t.notify();

}

}
}

}

When the workflow engine delivers the final LRT completion notification, it uses the LrtHelper class to wake up the thread that has been waiting for the LRT to complete:

public void lrtDone(TID t, ReturnStatus s) {

/ /wake up thread/ /
LrtHelper.signalLrtDone (t, s); }

Note that the transaction ID may also be a class:
public class TID {

public ReturnStatus s;
public TID() {

}

Alternative embodiments of the invention may be implemented, at least in part, as preprogrammed hardware elements (e.g., application specific integrated circuits, FPGAs, and digital signal processors), analog circuit elements, or other related components.

In other embodiments, the disclosed apparatus and method may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

APPENDIX A

public class LrtTest {

/ / running this program generates the following output:
/ / % java LrtTest
/ / Adding Jon.Smith
/ / Caught LRT Exception
/ / SUCCESS
/ / %
static LrtTest l = null;
static Workflow wf = null;
/ / this is the program main entry point
/ /
public static void main(String[] args) {
new LrtTest();
}
/ / this is the main test code.
/ /
LrtTest() {

/ / create the emulated workflow system
/ /
wf = new Workflow(l=this);
/ / emulate a resource issuing an add customer command. the data model
/ / of the resource encodes the customer name as a character array.
/ / print the result when done.
/ /
char [] customerName = {‘J’,‘o’,‘n’,‘.’,‘S’,‘m’,‘i’,‘i’,‘t’,‘h’};
ReturnStatus s = 1.add_customer(customerName);
System.out.println(s);

}
/ / this is the add_customer command in the originating adapter.
/ / it translates the data model of the resource (character array)
/ / into that needed by the common data model (string) and passes
/ / on the command to workflow.
/ /
/ / there are two catch clauses, one for the LRT exception and one
/ / for any other errors. If the LRT exception is caught, the
/ / system waits for the final completion notification using
/ / the LrtHelper class.
/ /
public ReturnStatus add_customer(char [] customerName) {

TID tid = new TID();
ReturnStatus s = new ReturnStatus(ReturnStatus.SUCCESS);
try {

String customerNameString = new String(customerName);
wf.add(tid, customerNameString);

} catch (LRTException e) {

System.out.println(“Caught LRT Exception”);
s = LrtHelper.waitForLrtDone(tid);

} catch (Exception e) {

s = new ReturnStatus(ReturnStatus.FAILURE);

}
return s;

}
/ / this is the function called when workflow delivers the
/ / final LRT completion notification. It uses the LrtHelper class
/ / to wake up the thread that's waiting for the LRT to complete.
/ /
public void lrtDone(TID t, ReturnStatus s) {

LrtHelper.signalLrtDone(t, s);

}
/ / LRT Exception class
/ /
public class LRTException extends Exception {

public LRTException() {

super();

}
public LRTException(String s) {

super(s);

}

}
/ / this class emulates workflow as well as the terminating
/ / adapter. The thread is used to simulate the LRT completion
/ / notification.
/ /
public class Workflow extends Thread {

TID t_;
LrtTest l_;
public Workflow(LrtTest l) {

l_ = l;

}
public void add(TID t, String customerName) throws LRTException {

t_ = t;
System.out.println(“Adding” + customerName);
start();
throw new LRTException();

}
public void run() {

try {

synchronized (this) {

wait(1000);

}

} catch (Exception e) {

e.printStackTrace();
System.exit(0);

}
l_.lrtDone(t_, new ReturnStatus(ReturnStatus.SUCCESS));

}

}

}

APPENDIX B

/ / simple transaction id
/ /
public class TID {

public ReturnStatus s;
public TiD() {
}

}

APPENDIX C

/ / this class provides synchronization help for long running transactions.
/ /
public class LrtHelper {

public static ReturnStatus waitForLrtDone(TID t) {

try {

synchronized (t) {

t.wait();

}

} catch (Exception e) {

return new ReturnStatus(ReturnStatus.FAILURE);

}
return t.s;

}
public static void signalLrtDone(TID t, ReturnStatus s) {

t.s = s;
synchronized (t) {

t.notify();

}

}

}

What is claimed is:

1. A method for processing a long running transaction for a service request, the method comprising:
receiving a service request at a workflow engine, the workflow engine being in communication with an original adapter and at least one receiving adapter, the original adapter generating the service request and the receiving adapter corresponding to a resource implementing a long running transaction in accordance with an instruction provided to the workflow engine by a business rule;
transmitting the instruction to the receiving adapter;
receiving an exception from the receiving adapter;
propagating the exception to the business rule;
propagating the exception to the original adapter;
receiving a notification from the at least one receiving adapter indicating that the long running transaction is done; and
propagating the notification to the original adapter when all instructions provided by the business rule have been executed.

2. A method according to claim 1, further comprising:
transmitting a commit call to the at least one receiving adapter; and
receiving a normal return in response to the commit call.

3. A method for implementing a manual repair capacity for service requests, the method comprising:
configuring a workflow engine to allow for manual repair, the workflow engine being in communication with at least one adapter;
receiving an exception with regard to a pending service request at the workflow engine;
transmitting a message to an operator interface to indicate to the operator that a repair is required; and
transmitting information about a service request to the operator interface.

4. A method according to claim 3, wherein the operator may re-throw the exception to the workflow engine.

5. A method according to claim 3, wherein the operator may re-try an instruction that resulted in the exception.

6. An apparatus for processing a long running transaction comprising;
an original adapter for generating a service request;
a receiving adapter corresponding to a resource executing a long running transaction in accordance with an instruction corresponding to the service request, the receiving adapter transmitting an exception when a long running transaction is executed; and
a workflow engine receiving the service request from the original adapter and sending the instruction corresponding to the service request to the receiving adapter, the workflow engine including a state machine indicating the long running transaction is pending and propagating the exception to the original adapter.

7. A method for integrating multiple resources in a service provider environment, the method comprising:
transmitting a service request to a workflow engine, the service request including one or more components to be executed in accordance with instructions provided by a business rule in communication with the workflow engine; and
receiving a notification that the one or more components of the service request have been executed.

8. A method according to claim 7, further comprising:
receiving an exception from the workflow engine when one of the components of the service request has not been executed.

9. A computer program product for implementing an adapter, the computer program product comprising a computer readable medium having computer code thereon, the computer code comprising:
program code for transmitting a service request in a system data model to a workflow engine; `
program code executable upon receiving a normal return from the workflow engine in response to the service request; and
program code executable upon receiving an exception from the workflow engine in response to the service request.

10. The computer program product of claim 9, further comprising program code for translating a service request in a resource data model into the service request in the system data model.

11. The computer program product of claim 9, wherein the program code executable upon receiving a normal return comprises code for indicating normal completion of the request to a resource that issued the service request.

12. The computer program product of claim 9, wherein the program code executable upon receiving an exception includes code for indicating failure of the request to a resource that issued the service request.

13 A method for processing in a workflow engine a service request that includes a long running transaction, the method comprising:
receiving a service request;
entering an active state for processing the service request;
sending instructions to receiving adapters in response to the service request;
receiving a long running transaction exception from one of the receiving adapters;
entering, responsive to the long running transaction exception, a long running transaction state during which a long running transaction completion may be received; and
entering a dormant state until receipt of an indication of long running transaction completion.

14. The method of claim 13, further comprising sending instructions to receiving adapters while in the long running transaction state.

15. The method of claim 14, wherein the dormant state is entered after all non-long running transaction instructions have been completed by the receiving adapters.
